(19) United States
(12) Patent Application Publication
(10) Pub. No.: US 2025/0060036 A1
(43) Pub. Date: Feb. 20, 2025

(54) ROTARY SHAFT SEAL

(71) Applicant: SAINT-GOBAIN PERFORMANCE PLASTICS CORPORATION, Solon, OH (US)

(72) Inventors: Mario BOSKOVSKI, Duesseldorf (DE); Sarah Shabbir, Antwerpen (BE); Mirco Gronitzki, Wertheim (DE)

(21) Appl. No.: 18/804,913

(22) Filed: Aug. 14, 2024

Related U.S. Application Data
(60) Provisional application No. 63/519,753, filed on Aug. 15, 2023.

(51) Int. Cl. F16J 15/3236; F16J 15/3228

(52) U.S. Cl. CPC F16J 15/3236; F16J 15/3228

(57) ABSTRACT

A rotary shaft seal including an annular body having an aperture defining a central axis and an inner surface; a shaft disposed within the aperture of the annular body; and a sealing element positioned at least partially between the shaft and the annular body, where the sealing element is configured to form a seal between the annular body and the shaft, where the sealing element includes a body having a U-shaped or a V-shaped cross-section including a plurality of lips, where at least one lip of the sealing element is fixed to at least one of the shaft or the annular body, and where a cavity exists between at least one of the plurality of lips and at least one of the shaft or the annular body.

### CROSS-REFERENCE TO RELATED APPLICATION(S)

This application claims priority under 35. U.S.C. § 119(e) to U.S. Provisional Application No. 63/519,753, entitled “ROTARY SHAFT SEAL,” by Mario BOSKOVSKI et al., filed Aug. 15, 2023, which is assigned to the current assignee hereof and incorporated herein by reference in its entirety for all purposes.

### FIELD OF THE DISCLOSURE

The present disclosure relates to shaft seals, and more particularly to shaft seals having a plurality of lips.

### RELATED ART

A rotary, or reciprocating, machine can feature an enclosed internal mechanism that drives a shaft. In some cases, the shaft can pass through the housing of the machine on one or both ends. In such cases, a rotary shaft seal, sometimes referred to as a lip seal, can be disposed near an exit point to retain a lubricating fluid, such as oil or grease, in the housing as well as prevent ingress of contaminants, such as moisture and dust. The rotary shaft seal can have an outer diameter that provides a seal against the housing, and a sealing lip that provides a seal against the shaft. The sealing lip should exert a radial load on the shaft that provides sufficient sealing properties without excessive friction or wear. In systems and environments with high operating speeds and chemically aggressive fluids, these rotary shaft seals can vary in performance and are often limited by the pressure levels on the seals themselves, leading to wear and eventually seal failure. Therefore, there continues to be a need for a rotary shaft seal having improved sealing properties in more extreme pressure conditions.

### BRIEF DESCRIPTION OF THE DRAWINGS

Embodiments are illustrated by way of example and are not limited in the accompanying figures.

FIG. 1A includes a cross-section plan view of a seal in accordance with an embodiment.

FIG. 1B includes a cross-section plan view of a seal in accordance with an embodiment.

FIG. 1C includes a cross-section plan view of a seal in accordance with an embodiment.

FIG. 1D includes a cross-section plan view of a seal in accordance with an embodiment.

FIG. 1E includes a cross-section plan view of a seal in accordance with an embodiment.

FIG. 1F includes a cross-section plan view of a seal in accordance with an embodiment.

FIG. 1G includes a cross-section plan view of a seal in accordance with an embodiment.

FIG. 2 includes a graph of distance (mm) between vs. contact pressure (MPa) of a conventional seal and a seal according to embodiments herein.

FIG. 3 includes a graph of distance (mm) between vs. contact pressure (MPa) of a conventional seal and a seal according to embodiments herein.

FIG. 4 includes a bar graph of radial load (N) of a conventional seal and a seal according to embodiments herein.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the shaft seal arts.

In a first embodiment, a shaft seal can generally include a body, i.e., an annular body, a sealing element disposed within the body, and a fixation element adapted to fix the sealing element to at least one of a shaft or an annular body.

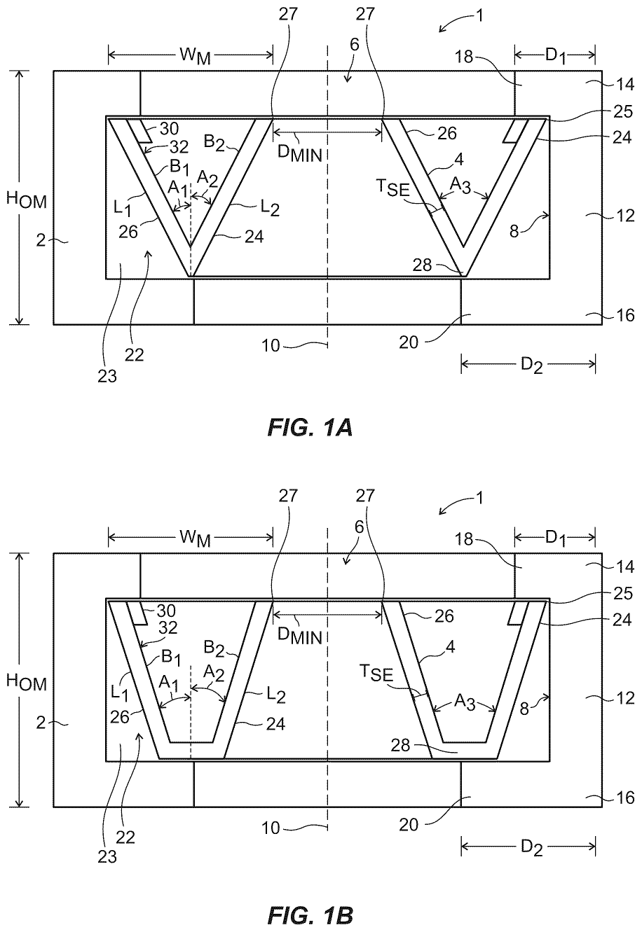

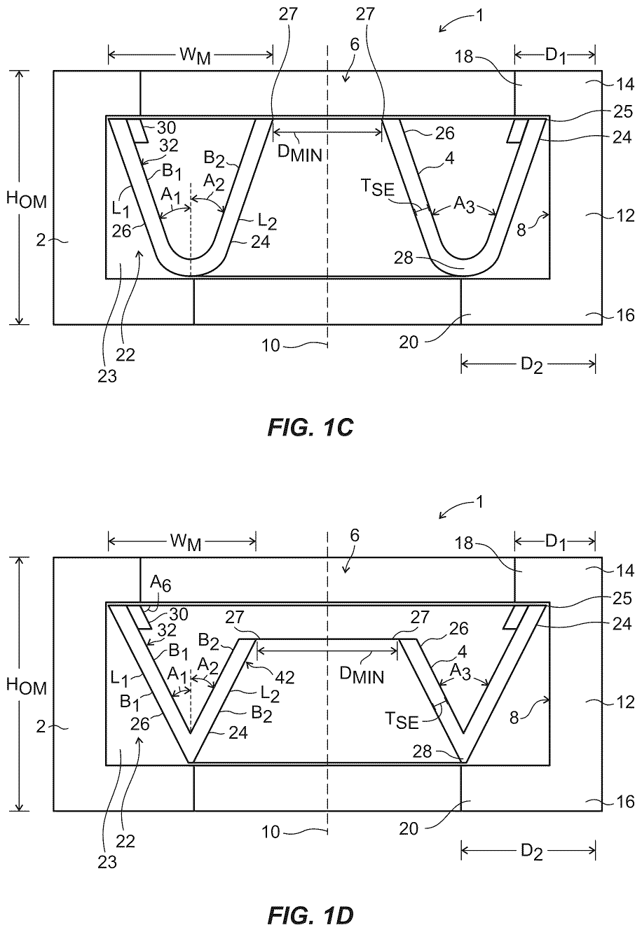

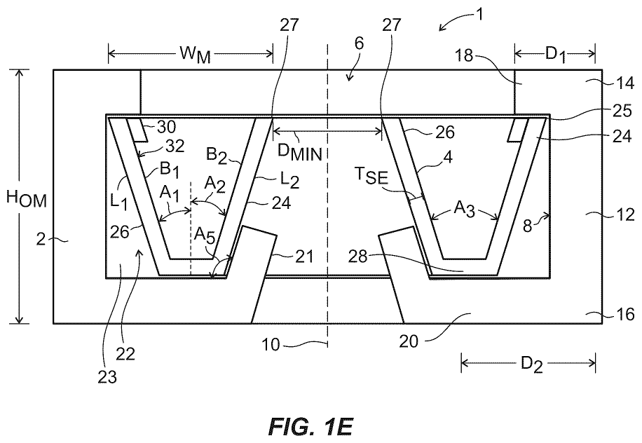

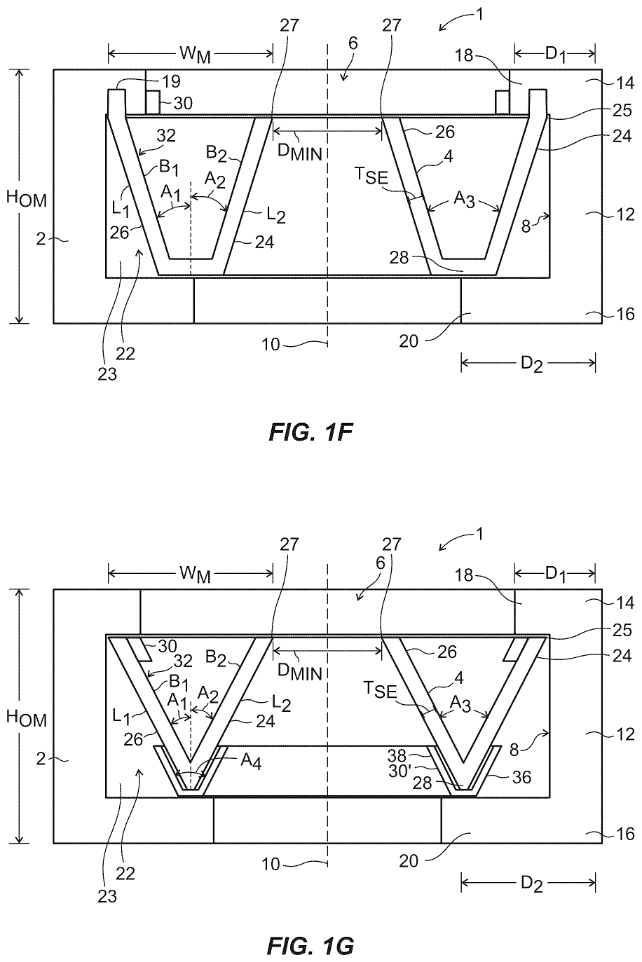

FIGS. 1A-1G include cross-section plan views of a seal in accordance with a number of embodiments. Referring initially to FIGS. 1A-1G, a seal 1 can generally include an annular body 2 and a sealing element 4 positioned at least partially within the annular body 2.

The annular body 2 can comprise a material having a Brinell hardness (HB) in a range between and including about 70 to about 150, such as in a range between about 75 to about 145, in a range between about 80 to about 140, in a range between about 85 to about 135, in a range between about 90 to about 130, in a range between about 95 to about 125, in a range between about 100 to about 120, or even in a range between about 105 to about 115.

In another aspect, the annular body 2 can comprise a material having a Modulus of Elasticity (MOE) of between about 10 MPa and about 1000 MPa, such as between about 15 MPa and about 750 MPa, between about 20 MPa and about 500 MPa, between about 30 MPa and about 250 MPa, between about 45 MPa and about 200 MPa, between about 75 MPa and about 150 MPa, or even between about 90 MPa and about 130 MPa. In a more particular embodiment, the annular body 2 can comprise a material having an MOE of between about 100 MPa and about 125 MPa.

In a further aspect, the annular body 2 can comprise a material having a coefficient of thermal expansion (CTE) of between about 1×10⁻⁶ in/in° F. and about 75×10⁻⁶ in/in° F., such as between about 2×10⁻⁶ in/in° F. and about 50×10⁻⁶ in/in° F., between about 3×10⁻⁶ in/in° F. and about 25×10⁶ in/in° F., between about 5×10⁻⁶ in/in° F. and about 15×10⁻⁶ in/in° F., or even between about 7×10⁻⁶ in/in° F. and about 11×10⁻⁶ in/in° F.

In yet a further aspect, the annular body 2 can comprise a material having an elongation at break (EAB) of no greater than about 60%, such as no greater than about 55%, no greater than about 50%, no greater than about 45%, no greater than about 40%, no greater than about 30%, no greater than about 20%, or even no greater than about 10%. In further embodiments, the annular body 2 can comprise a material having an EAB of no less than about 0.5%, such as no less than about 1%, no less than about 2%, or even no less than about 5%. Moreover, the annular body 2 can comprise a material having an EAB within a range between and including any of the values described above, such as, for example, between about 45% and about 55%.

In certain embodiments, the annular body 2 can comprise a metal. For example, in particular embodiments, the annular body 2 can comprise aluminum, bronze, copper, steel, or lead. In a particular embodiment, the annular body 2 can include a polymer.

In other embodiments, the annular body 2 can comprise an alloy. For example, in non-limiting embodiments, the annular body 2 can comprise a copper-zinc alloy, a copper-zinc-lead alloy, a copper-nickel-zinc alloy, a leaded copper, brass, bronze, iron, a ferroalloy, or even steel. The present disclosure is not intended to be limited in any way by the material of the annular body 2 as described in the above embodiments.

For example, in yet other embodiments, the annular body 2 can comprise a polymer, such as, for example, ultra-high molecular weight polyurethane (UHMWPE), poly(vinyl chloride) (PVC), aliphatic polyamides, POM, PEEK, PPS, PEI, or even para-aramids such as Kevlar®. In yet other embodiments, the annular body 2 can comprise a rubber which may include at least one of fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), natural polyisoprene, synthetic polyisoprene, polybutadiene, chloroprene rubber, butyl rubber, styrene-butadiene rubber, nitrile rubber, ethylene propylene, rubber, ephichlorohydrin rubber, polyacrylic rubber, silicone rubber, fluorosilicone rubber, fluoroelastomers, perfluoroelastomers, polyether block amides, chlorosulfonated polyethylene, ethyl-vinyl acetate (EVA), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof.

In certain embodiments, the annular body 2 may include a thermoplastic polymer. For example, the annular body 2 can comprise materials including a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof. Fluoropolymers are used according to particular embodiments.

In certain embodiments, the annular body 2 may include a thermoset polymer. For example, the annular body 2 can comprise materials including a polyester, polyurethane, polyurea, rubber, melamine, Diallyl-phthalate, epoxy, enzoxazines, polyimide, cyanate ester, silicon resins, thiolyte, vinyl ester, or may be another type.

The annular body 2 can be generally cylindrical and can further include an aperture 6 defining an inner surface 8 and a central axis 10. In a particular aspect, the aperture 6 can be coaxial, or substantially coaxial, with the central axis 10.

In certain embodiments, the annular body 2 can be formed from multiple components connected together. The multiple components may be engaged to form the annular body 2 by any method recognizable in the art, such as, for example, by melting, sintering, welding, molded, compressed, threaded or non-threaded engagement, or any combination thereof.

The annular body 2 can comprise a homogenous composition or may comprise two or more discrete portions having different compositions.

Moreover, in one non-limiting embodiment, although not applicable to all embodiments, the annular body 2 may not include a polymer, and more particularly, may be essentially free of any/all polymers. In a particular aspect, the annular body 2 may comprise a single material free of any coating or surface layer.

The annular body 2 can be untreated or treated to enhance the physical or chemical properties thereof. For example, in particular embodiments, the annular body 2 can be treated using techniques such as laser melting or ablation, mechanical sandblasting or chemical picking. In further embodiments, the annular body 2 can be treated by galvanizing, chromate or phosphate treatments, or anodizing.

In a particular aspect, the annular body 2 can have a generally C-shaped cross-section when viewed in a direction perpendicular to a plane extending radially from the central axis 10. In another aspect, the annular body 2 can have any other shape when viewed in a direction perpendicular to a plane extending radially from the central axis 10, such as, for example, a generally I-shape, a generally J-shape, or even a generally L-shape.

In particular embodiments, the annular body 2 can define an outer member 12 having a first axial end 14 and a second axial end 16 opposite the first radial end 14. A first flange 18 can be disposed proximate the first axial end 14 of the outer member 12 and can extend radially inward therefrom. A second flange 20 can be disposed proximate the second axial end 16 of the outer member 12 and can extend radially inward therefrom.

The first and second flanges 18 and 20 can each extend a radial distance, D₁ and D₂, respectively, as measured from the innermost surface of the outer member 12.

In some embodiments, D₁ can be equal to D₂.

In other embodiments, D₁ can be no less than D₂. For example, D₁/D₂ can be at least about 1.01, such as at least about 1.05, at least about 1.25, at least about 1.50, at least about 1.75, at least about 2.0, at least about 2.25, at least about 2.50, at least about 2.75, or even at least about 3.0. In further embodiments, D₁/D₂ can be no greater than about 6.0, such as no greater than about 5.0, no greater than about 4.0, or even no greater than about 3.5. Moreover, D₁/D₂ can be within a range between and including any of the values described above, such as, for example, between about 2.0 and about 2.75.

In some embodiments, as shown in FIG. 1F, the first and second flanges 18, 20 may have ending projections. As shown in FIG. 1E, the second flange 20 may have a projection 21. Alternatively, as shown in FIG. 1F, the first flange 18 may have a projection 19. The projections 19, 21 may extend at an angle, A₅, with a line parallel to the first or second flange 18, 20. In particular embodiments, A₅ can be greater than about 10 degrees, such as greater than about 15 degrees, greater than about 30 degrees, greater than about 45 degrees, greater than about 90 degrees, or even greater than about 120 degrees. In further embodiments, A₅ can be less than about 180 degrees, such as less than about 150 degrees, less than about 120 degrees, or even less than about 90 degrees. Moreover, A₅ can be within a range between and including any of the values described above, such as, for example, between about 10 degrees and about 45 degrees. As shown in FIG. 1F, the first flange 18 may have a projection 19 extending at least partially axially and acting as a partial fixation, as described in further detail below.

The outer member 12 can have a height, H_{OM}, as measured by a distance between the first and second axial ends 14 and 16. In particular embodiments, H_{OM}/D₂ can be at least about 0.5, such as at least about 0.75, at least about 1.0, at least about 1.25, at least about 1.5, or even at least about 2.0. In further embodiments, H_{OM}/D₂ can be no greater than about 8.0, such as no greater than about 7.0, no greater than about 6.0, no greater than about 5.0, no greater than about 4.0, or even no greater than about 3.0. Moreover, H_{OM}/D₂ can be within a range between and including any of the values described above, such as, for example, between about 1.75 and about 2.25.

In certain embodiments, H_{OM}/D₁ can be at least about 0.75, such as at least about 1.0, at least about 1.25, at least about 1.5, or even at least about 2.0. In further embodiments, H_{OM}/D₁ can be no greater than about 10.0, such as no greater than about 9.0, no greater than about 8.0, no greater than about 7.0, no greater than about 6.0, or even no greater than about 5.0. Moreover, H_{OM}/D₁ can be within a range between and including any of the values described above, such as, for example, between about 2.0 and about 2.5.

In particular embodiments, the annular body 2 can define an annular cavity 22 extending into the annular body 2 radially outward from the central axis 10 and/or concentric to the central axis 10 of the aperture 6. The annular cavity 22 can be coaxial to the central axis 10. In a certain aspect, the annular cavity 22 can be contained within a space formed between the inner surface 8 of the outer member 12 and the first and second flanges 18 and 20.

The annular cavity 22 can define a generally rectilinear cross-section when viewed in a direction perpendicular to a plane extending radially from the central axis 10. Moreover, the annular cavity can comprise one or more fillets, rounded edges, angular components, or any combination thereof.

Still referring to FIGS. 1A-1G, the sealing element 4 can be at least partially disposed within the annular body 2. Specifically, the sealing element 4 can be partially disposed within the annular cavity 22 of the annular body 2.

The sealing element 4 can define at least one lip element. A lip element may be defined as a discrete axial end of the sealing element 4 in relation to the central axis 10. In a particular embodiment, the sealing element 4 can define a first flange 24 ending in a first lip element 25 and a second flange 26 ending in a second lip element 27. At least one of the first flange 24 or second flange 26 of the sealing element 4 can be disposed between the first and second flanges 18 and 20 of the annular body 2. A member 28 can extend between, or join, the first and second flanges 24 and 26. In an embodiment, the sealing element 4 may have a first axial end and a second axial end, a first lip element 25 disposed proximate the first axial end of sealing element 4 and extending at least partially radially inward, and a second lip element 27 disposed proximate the second axial end of the sealing element 4 and extending at least partially radially inward.

The first and second flanges 24 and 26 can each extend a length, L₁ and L₂, respectively, as measured from the member 28. In a particular embodiment, L₁ can be equal to L₂ (FIG. 1A).

In another embodiment, L₂ can be no less than L₁ (not shown). For example, L₂/L₁ can be at least about 1.01, such as at least about 1.05, at least about 1.25, at least about 1.50, at least about 1.75, at least about 2.0, at least about 2.25, at least about 2.50, at least about 2.75, or even at least about 3.0. In further embodiments, L₂/L₁ can be no greater than about 6.0, such as no greater than about 5.0, no greater than about 4.0, or even no greater than about 3.5. Moreover, L₂/L₁ can be within a range between and including any of the values described above, such as, for example, between about 1.05 and about 1.25.

In another embodiment, L₁ can be no less than L₂ (FIG. 1D). For example, L₁/L₂ can be at least about 1.01, such as at least about 1.05, at least about 1.25, at least about 1.50, at least about 1.75, at least about 2.0, at least about 2.25, at least about 2.50, at least about 2.75, or even at least about 3.0. In further embodiments, L₁/L₂ can be no greater than about 6.0, such as no greater than about 5.0, no greater than about 4.0, or even no greater than about 3.5. Moreover, L₁/L₂ can be within a range between and including any of the values described above, such as, for example, between about 1.05 and about 1.25.

In certain embodiments, the sealing element 4 can have a radial width, W_{M}, as measured by a maximum radial distance between the first and second flanges 24 and 26 in the undeformed state. W_{M}/L₂ can be at least about 0.05, such as at least about 0.1, at least about 0.25, at least about 0.5, at least about 0.75, or even at least about 1.0. W_{M}/L₂ can be no greater than about 3.0, such as no greater than about 2.0, no greater than about 1.5, no greater than about 1.25, or even no greater than about 1.05. Moreover, W_{M}/L₂ can be within a range between and including any of the values described above, such as, for example, between about 0.15 and about 0.25.

The first flange 24 can have a relative angle, A₁, as measured against the member 28 in the undeformed state, i.e., prior to engagement of the seal 1 with a shaft. In particular embodiments, A₁ can be greater than about 90 degrees, such as greater than about 100 degrees, greater than about 110 degrees, greater than about 120 degrees, greater than about 130 degrees, or even greater than about 140 degrees. In further embodiments, A₁ can be less than about 180 degrees, such as less than about 170 degrees, less than about 160 degrees, or even less than about 150 degrees. Moreover, A₁ can be within a range between and including any of the values described above, such as, for example, between about 105 degrees and about 115 degrees.

Similarly, the second flange 26 can have a relative angle, A₂, as measured against the member 28 in the undeformed state. In particular embodiments, A₂ can be greater than about 90 degrees, such as greater than about 100 degrees, greater than about 110 degrees, greater than about 120 degrees, greater than about 130 degrees, or even greater than about 140 degrees. In further embodiments, A₂ can be less than about 180 degrees, such as less than about 170 degrees, less than about 160 degrees, or even less than about 150 degrees. Moreover, A₂ can be within a range between and including any of the values described above, such as, for example, between about 105 degrees and about 115 degrees.

In the undeformed state, angles A₁ and A₂ can be the same or different. Moreover, L₁ and L₂ can be the same or different. In this regard, the sealing element 4 does not require a symmetrical cross-section when viewed in a direction perpendicular to a plane extending radially from the central axis 10.

Referring to FIG. 1A, in a particular embodiment, the sealing element 4 can comprise a generally V-shaped cross-section when viewed in a direction perpendicular to a plane extending radially from the central axis 10. In other embodiments, such as illustrated in FIGS. 1B and 1C, the sealing element 4 can comprise any other shape, such as, for example, a generally rectilinear U-shape (where the member 28 is substantially rectilinear), a generally arcuate U-shape (where the member 28 is substantially arcuate), or any combination thereof. The first and second flanges 24 and 26 can form a relative angle, A₃, as measured therebetween in the undeformed state. In a certain aspect, A₃ can be no less than about 20 degrees, such as no less than about 30 degrees, no less than about 40 degrees, no less than about 50 degrees, no less than about 60 degrees, no less than about 70 degrees, no less than about 80 degrees, or even no less than about 90 degrees. In another aspect, A₃ can be no greater than about 150 degrees, such as no greater than about 140 degrees, no greater than about 130 degrees, no greater than about 120 degrees, no greater than about 110 degrees, or even no greater than about 100 degrees. Moreover, A₃ can be within a range between and including any of the values described above, such as, for example, between about 45 degrees and about 55 degrees.

In a certain aspect, the sealing element 4 can be formed from a monolithic construction. In another aspect, the sealing element 4 can be formed from multiple components joined together by any means recognizable in the art, such as, for example, by mechanical deformation (e.g., crimping or splines), adhesive, welding, melting, or any combination thereof.

In particular embodiments, the sealing element 4 can comprise a material having a Modulus of Elasticity (MOE) of no less than about 0.01 gigapascal (GPa), such as no less than about 0.5 GPa, no less than about 0.75 GPa, or even no less than about 1.0 GPa. In further embodiments, the sealing element 4 can comprise a material having an MOE of no greater than about 5.0 GPa, such as no greater than about 4.0 GPa, no greater than about 3.0 GPa, no greater than about 2.0 GPa, or even no greater than about 1.5 GPa. Moreover, the sealing element 4 can comprise a material having an MOE within a range between and including any of the values described above, such as, for example, between about 0.45 and about 1.5.

In certain embodiments, the sealing element 4 can comprise a polymer. In certain embodiments, the sealing element comprises a thermoplastic polymer. For example, the sealing element 4 can comprise materials including a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof. Fluoropolymers are used according to particular embodiments.

In a particular embodiment, the sealing element 4 can comprise a material having a low temperature hard coating, such as, for example, a diamond-like coating (DLC) impregnated therein. In particular embodiments, the DLC can have a lattice structure similar to a diamond, wherein each carbon atom comprises four carbon atoms equally spaced. Alternatively, the sealing element 4 can comprise a material impregnated therein by use of a high velocity oxygen fuel (HVOF) coating. HVOF coatings can extend sealing surface life by significantly increasing the sealing element's resistance to wear and corrosion. Moreover, HVOF coatings can affect a smoother surface finish with bond strengths in excess of approximately 10,000 pounds per square inch.

In a particular aspect, the sealing element 4 can further include one or more fillers, such as graphite, glass, aromatic polyester (EKONOL®), bronze, zinc, boron nitride, carbon, and/or polyimide. Concentrations of each of these fillers in a polymer such as PTFE may be greater than 1%, such as greater than 5%, greater than 10%, or even greater than 20% by weight.

In addition, the sealing element 4 can further include lubrication to enhance sliding characteristics against the shaft. Exemplary lubricants can include molybdenum disulfide, tungsten disulfide, graphite, grapheme, expanded graphite, boron nitrade, talc, calcium fluoride, or any combination thereof. Additionally, the lubricant can comprise alumina, silica, titanium dioxide, calcium fluoride, boron nitride, mica, Wollastonite, silicon carbide, silicon nitride, zirconia, carbon black, pigments, or any combination thereof.

Referring still to FIG. 1A, the sealing element 4 can comprise a thickness, T_{SE}, when viewed in a direction perpendicular to a plane extending radially from the central axis 10. In a particular aspect, T_{SE} can vary or be substantially uniform throughout the sealing element 4.

In particular embodiments, T_{SE} can be no less than about 0.05 inches, such as no less than about 0.10 inches, no less than about 0.15 inches, or even no less than about 0.20 inches. In further embodiments, T_{SE} can be no greater than about 1.5 inches, no greater than about 1.25 inches, no greater than about 1.0 inches, no greater than about 0.75 inches, no greater than about 0.5 inches, or even no greater than about 0.25 inches. Moreover, T_{SE} can be within a range between and including any of the values described above.

In another embodiment, the sealing element 4 can have a total width, W_{SE}, when viewed in a direction perpendicular to a plane extending radially from the central axis 10, i.e., L₁+L₂+W_{M}, and W_{SE}/T_{SE} can be at least about 10, such as at least about 25, at least about 50, at least about 75, at least about 100, at least about 125, at least about 150, or even at least about 200. In further embodiments, W_{SE}/T_{SE} can be no greater than about 1000, such as no greater than about 900, no greater than about 800, no greater than about 700, no greater than about 600, no greater than about 500, no greater than about 400, or even no greater than about 300. Moreover, W_{SE}/T_{SE} can be within a range between and including any of the values described above, such as, for example, between about 30 and about 45.

Still referring to FIGS. 1A-1G, a fixation element 30 can be at least partially disposed within the annular body 2. Specifically, the fixation element 30 can be partially disposed within the annular cavity 22 of the annular body 2. The fixation element may be adapted to fix the at least one lip element (25, 27) to at least one of the shaft or annular body 2. In certain embodiments as stated above, the fixation element can further include a biasing element positioned adjacent the sealing element 4.

In a number of embodiments, a secondary cavity 23 may be present between the sealing element 4 and the annular body 2 in an installed state. The secondary cavity 23 can define a generally rectilinear cross-section when viewed in a direction perpendicular to a plane extending radially from the central axis 10. The secondary cavity 23 can define a generally arcuate cross-section when viewed in a direction perpendicular to a plane extending radially from the central axis 10. The secondary cavity 23 can define a generally rectilinear and an arcuate cross-section when viewed in a direction perpendicular to a plane extending radially from the central axis 10.

Moreover, the secondary cavity 23 can comprise one or more fillets, rounded edges, angular components, or any combination thereof. The secondary cavity 23 may provide room for radial expansion of the seal 1, providing better sealing of the seal 1 against neighboring components (e.g. shaft).

In certain embodiments, the sealing element 4 can be disposed between the fixation element 30 and the annular body 2 when viewed in a direction perpendicular to a plane extending radially from the central axis 10. In such a manner, the fixation element 30 can apply an at least partially radial force against at least a portion of the sealing element 4 to fix the sealing element 4 to the annular body 2.

In some embodiments, the fixation element 30 may include a chemical fixation. The chemical fixation may include welding, melting, or use of an adhesive including at least one of fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), copolymers thereof, or any combination thereof (including mechanical fixation elements). In some embodiments, the fixation element 30 may include a mechanical fixation. The mechanical fixation may include at least one of nuts, bolts, bearings, battens, buckles, clips, flanges, frogs, grommets, hook-and-eyes, latches, pegs, nails, rivets, tongue- and grooves (e.g. FIG. 1F), screw anchors, snap fasteners, stitches, threaded fasteners, ties, toggle bolts, wedges anchors, screws, biasing element, bolts, clamps, clasps, clips, latches, pins, rivets, ties, nails, by mechanical deformation (e.g., crimping or splines), or any combination thereof (including chemical fixation elements).

In more particular embodiments, the fixation element 30 can be positioned at least partially along an inner surface 32 of the sealing element 4, such as, radially inside at least one of the lip elements of the sealing element 4. In such a manner, the fixation element 30 can provide a radial biasing force to at least one of the first and second flanges 24 and 26 of the sealing element 4.

The fixation element 30 may be positioned along the inner surface 32 of the sealing element 4 at an angle, A₅, with a line parallel to the first or second flange 18, 20. In particular embodiments, A₅ can be greater than about 10 degrees, such as greater than about 15 degrees, greater than about 30 degrees, greater than about 45 degrees, greater than about 90 degrees, or even greater than about 120 degrees. In further embodiments, A₅ can be less than about 180 degrees, such as less than about 150 degrees, less than about 120 degrees, or even less than about 90 degrees. Moreover, A₅ can be within a range between and including any of the values described above, such as, for example, between about 10 degrees and about 45 degrees. As shown in FIG. 1F, the first flange 18 may have a projection 19 extending at least partially axially and acting as a partial fixation, as described in further detail below.

In certain embodiments, the fixation element 30 can comprise a spring adapted to bias at least a portion of the sealing element 4 in a radial, or substantially radial, direction. In more particular embodiments, the fixation element 30 can comprise an annular spring such as, for example, a garter spring, a rimmed spring, or a compression spring (helical spring) bent to form a torus.

In a non-limiting embodiment, the fixation element 30 can comprise a generally planar cross-section when viewed in a direction perpendicular to a plane extending at least partially radially. In other embodiments, the fixation element 30 can comprise any other shape, such as, for example, a generally V-shape, a generally U-shape, a generally C-shape, or any combination thereof.

In certain embodiments, the fixation element 30 can include an axial gap 34 extending at least partially along the axial length thereof. The axial gap 34 can permit easier manufacture and assembly of the seal 1 as compared to a circumferentially continuous biasing element devoid of an axial gap. In certain embodiments, the circumferential edges formed by the axial gap 34 can be secured together to form a continuous body. The circumferential edges can be secured by any known process for joining adjacent bodies, such as, for example, by welding, mechanical deformation (e.g., crimping), adhesive, fasteners (threaded or non-threaded) or any combination thereof.

In some embodiments, the fixation may be in a V-shape. In some embodiments, as shown in FIG. 1G, the fixation element 30 can comprise an annular member 36 and an annular flange 38 extending from the annular member 36. A relative angle, A₄, can be formed between the annular member 36 and the annular flange 38, as viewed in the undeformed state, i.e., prior to engagement with the sealing element 4. In a particular embodiment, A₄ can be greater than about 90 degrees, such as greater than about 100 degrees, or even greater than about 110 degrees. In further embodiments, A₄ can be less than about 150 degrees, such as less than about 140 degrees, less than about 130 degrees, or even less than about 120 degrees. Moreover, A₄ can be within a range between and including any of the values described above, such as, for example, between about 110 degrees and about 120 degrees.

The annular member 36 of the fixation element 30 can have a radial width, W_{AM}, and the annular flange 38 can have a radial length, L_{AF}, as measured by a distance the annular flange 38 extends from the annular member 36. In certain embodiments, L_{A}V/W_{M} can be no less than about 1.0, such as no less than about 1.25, no less than about 1.5, no less than about 1.75, or even no less than about 2.0. In other embodiments, L_{AF}/W_{AM} can be no greater than about 10, such as no greater than about 5.0, no greater than about 4.0, no greater than about 3.0, or even no greater than about 2.5. Moreover, L_{AF}/W_{AM} can be within a range between and including any of the values described above, such as, for example, between about 4.0 and about 4.5.

In certain embodiments, the fixation element 30 can comprise a material having a Modulus of Elasticity of no less than about 5.0 gigapascals (GPa), such as no less than about 10.0 GPa, no less than about 25.0 GPa, no less than about 50 GPa, no less than about 100 GPa, or even no less than about 150 GPa. In a further embodiment, the fixation element 30 can comprise a material having a Modulus of Elasticity of no greater than about 300 GPa, such as no greater than about 250 GPa, or even no greater than about 225 GPa. Moreover, the fixation element 30 can comprise a material having a Modulus of Elasticity within a range between and including any of the values described above, such as, for example, between about 120 MPa and about 180 MPa.

In a particular aspect, the fixation element 30 can comprise a material having a tensile strength of no less than about 1000 megapascals (MPa), such as no less than about 1200 MPa, or even no less than about 1500 MPa. In a further embodiment, the fixation element 30 can comprise a material having a tensile strength of no greater than about 2500 megaPascals (MPa), such as no greater than about 2000 MPa, or even no greater than about 1800 MPa. Moreover, the fixation element 30 can comprise a material having a tensile strength within a range between and including any of the values described above, such as, for example, between about 1600 MPa and about 1750 MPa.

In another aspect, the fixation element 30 can comprise a material having a coefficient of thermal expansion (CTE) of between approximately 5.0×10⁻⁶ in/in° F. and approximately 15.0×10⁻⁶ in/in° F., such as between approximately 7.0×10⁻⁶ in/in° F. and approximately 12.0×10⁻⁶ in/in° F., between approximately 8.5.0×10⁻⁶ in/in° F. and approximately 11.5×10⁻⁶ in/in° F., or even between approximately 10.0×10⁻⁶ in/in° F. and approximately 10.5×10⁻⁶ in/in° F.

In specific embodiments, the fixation element 30 can comprise a metal. In yet more particular embodiments, the fixation element 30 can comprise a steel, such as a spring steel.

As shown in FIGS. 1A-1G, the sealing element 4 can have a minimum diameter D_{MIN}, as measured by a smallest distance between diametrically opposite internal sides of the sealing element 4. A person of ordinary skill in the art will understand that the diameter D_{MIN} of the sealing element 4 in a free state, i.e., prior to engagement with the shaft, can be smaller than the diameter of the shaft 100. In such a manner, the seal 1, i.e., the sealing element 4 can form an effective seal against the shaft 100. Optionally, as shown in FIG. 1G, the seal 1 can include a second fixation element 30′ adapted to provide a biasing force on the sealing element 4. The second fixation element 30′ may include any fixation element or combination of fixation elements of the embodiments listed above. As shown in FIG. 1F, the second fixation element 30′ may be located on an opposite axial end from the first fixation element.

In particular embodiments, the fixation element 30, when installed in the seal 1, can be adapted to provide a radial biasing force of at least about 1.0 kilopascal (KPa), such as at least about 5 KPa, at least about 10 KPa, at least about 25 KPa, at least about 50 KPa, at least about 100 KPa, or even at least about 250 KPa. In further embodiments, the fixation element 30 can be adapted to provide a biasing force of no greater than about 500 KPa, such as no greater than about 400 KPa, or even no greater than about 300 KPa. Moreover, the fixation element 30 can be adapted to provide a biasing force within a range between and including any of the values described above, such as, for example, between about 225 KPa and about 275 KPa.

In particular embodiments, the seal 1 can be adapted to receive a shaft 100 having a diameter of no greater than about 50 mm, such as no greater than about 15 mm, no greater than about 10 mm, no greater than about 9 mm, no greater than about 8 mm, no greater than about 7 mm, no greater than about 6 mm, or even no greater than about 5 mm. In other embodiments, the seal 1 can be adapted to receive a shaft having a diameter of between about 51 mm and about 100 mm. In yet further embodiments, the seal 1 can be adapted to receive a shaft having a diameter of greater than 100 mm.

The seal 1 can be adapted to operate within a wide temperature range while simultaneously maintaining effective sealing rates. For example, the seal 1 can be adapted to operate at temperatures within a range between about −275° C. and about 300° C., such as within a range between about −250° C. and about 250° C., within a range between about −100° C. and about 100° C., or even within a range between about −40° C. and about 20° C., while exhibiting a leakage rate of less than about 10 mL/min/mm, such as less than about 9 mL/min/mm, less than about 8 mL/min/mm, less than about 7 mL/min/mm, less than about 6 mL/min/mm, less than about 5 mL/min/mm, less than about 4 mL/min/mm, less than about 3 mL/min/mm, less than about 2 mL/min/mm, less than about 1 mL/min/mm, less than about 0.75 mL/min/mm, less than about 0.5 mL/min/mm, less than about 0.25 mL/min/mm, less than about 0.1 mL/min/mm, or even less than about 0.01 mL/min/mm. Moreover, the seal 1 can be adapted to operate within the above described temperature range while having a leakage rate of about 0 mL/min/mm.

In some embodiments, as shown in FIGS. 1A-1G, the first and second flanges 24, 26 (or lip elements 25, 27) of the sealing element 4 may have inner surface areas directed toward a first axial end of the seal 1. The first flange 24 (or first lip element 25) may have an inner surface area, B₁. The second flange 26 (or first lip element 27) may have an inner surface area, B₂. In certain embodiments, B₂/B₁ can be no greater than about 1.0, such as no greater than about 0.95, such as no greater than 0.9, such as no greater than 0.8, such as no greater than 0.7, such as no greater than 0.6, or such as no greater than 0.5. In other embodiments, B₂/B₁ can be no less than 0.1, such as no less than 0.2, no less than 0.3, no less than 0.4, or even no less than about 0.5. Moreover, B₂/B₁ can be within a range between and including any of the values described above, such as, for example, between about 0.5 and about 0.75.

In some embodiments, as shown in FIGS. 1A-1B, the first and second flanges 24, 26 (or lip elements 25, 27) of the sealing element 4 may have inner surface areas directed toward a first axial end of the seal 1. The first flange 24 (or first lip element 25) may have an inner surface area, B₁. The second flange 26 (or first lip element 27) may have an inner surface area, B₂. In certain embodiments, B₂/B₁ can be no greater than about 1.0, such as no greater than about 0.95, such as no greater than 0.9, such as no greater than 0.8, such as no greater than 0.7, such as no greater than 0.6, or such as no greater than 0.5. In other embodiments, B₂/B₁ can be no less than 0.1, such as no less than 0.2, no less than 0.3, no less than 0.4, or even no less than about 0.5. Moreover, B₂/B₁ can be within a range between and including any of the values described above, such as, for example, between about 0.5 and about 0.95.

In a number of embodiments, a method is shown including: providing an annular body 2 having an aperture 6 defining a central axis 10 and an inner surface 8; providing a shaft; positioning a sealing element 4 at least partially between the shaft and the annular body 2, where the sealing element 4 may be configured to form a seal between the annular body 2 and the shaft, where the sealing element 2 has a U-shaped or a V-shaped cross-section including at least one lip element 25, 27; and fixing the at least one lip element 25, 27 of the sealing element 4 to at least one of the shaft or the annular body 2, where a cavity 23 exists between the at least one lip element 25, 27 and at least one of the shaft or the annular body 2.

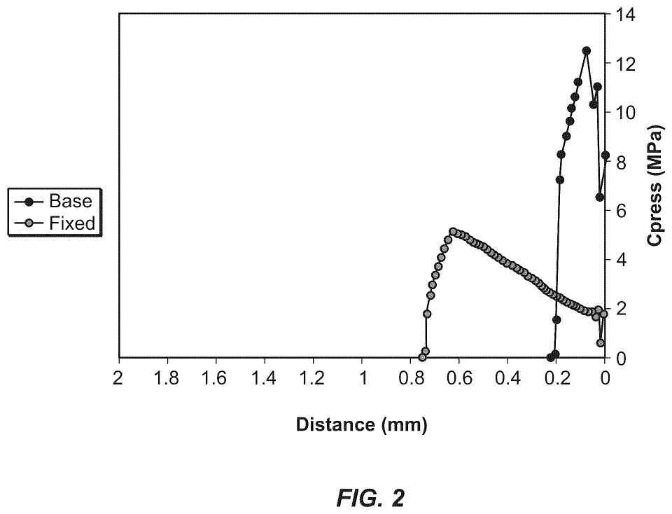

FIG. 2 shows a graph of distance (mm) between vs. contact pressure (MPa) of a conventional seal and a seal according to embodiments herein. As shown in FIG. 2, the seal according to embodiments herein exhibit a higher contact pressure at a shorter distance, resulting in improved leakage performance for the seal according to embodiments herein vs. conventional seals. Through use of at least one of the secondary cavity 26, fixation element 30, or surface area ratio B₂/B₁ of the first and second flanges 24, 26 (or lip elements 25, 27), the seal 1 may have an improved pressure relationship on at least one axial side of the seal 1.

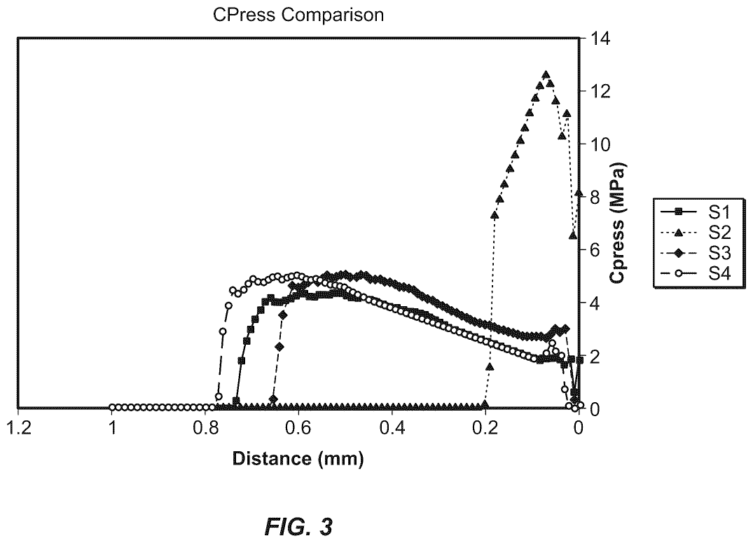

FIG. 3 shows a graph of distance (mm) between vs. contact pressure (MPa) of a conventional seal and a seal according to embodiments herein. S1 indicates a conventional seal with no fixation and a B₂/B₁ of less than 0.95. S2 indicates a seal according to embodiments herein with fixation and a B₂/B₁ of less than 0.95. S3 indicates a seal according to embodiments herein with fixation and a B₂/B₁ of 0.96. S4 indicates a seal according to embodiments herein with fixation and a B₂/B₁ of 1. As shown in FIG. 3, the seal according to embodiments herein exhibit a higher contact pressure at a shorter distance, resulting in improved leakage performance for the seal according to embodiments herein vs. conventional seals, surprisingly and in particular, when B₂/B₁ is less than 0.95. Through use of at least one of the secondary cavity 26, fixation element 30, or surface area ratio B₂/B₁ of the first and second flanges 24, 26 (or lip elements 25, 27), the seal 1 may have an improved pressure relationship on at least one axial side of the seal 1.

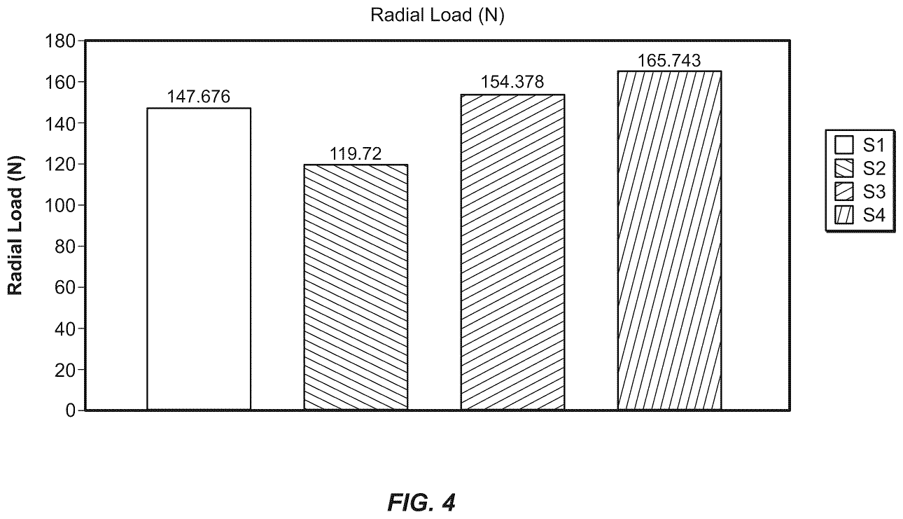

FIG. 4 shows a bar graph of radial load (N) of a conventional seal and a seal according to embodiments herein. S1 indicates a conventional seal with no fixation and a B₂/B₁ of less than 0.95. S2 indicates a seal according to embodiments herein with fixation and a B₂₁/B₁ of less than 0.95. S3 indicates a seal according to embodiments herein with fixation and a B₂/B₁ of 0.96. S4 indicates a seal according to embodiments herein with fixation and a B₂/B₁ of 1. As shown in FIG. 3, the seal according to embodiments herein exhibit a higher force at a longer time, resulting in improved leakage performance for the seal according to embodiments herein vs. conventional seals, surprisingly and in particular, when B₂/B₁ is less than 0.95. Through use of at least one of the secondary cavity 26, fixation element 30, or surface area ratio B₂/B₁ of the first and second flanges 24, 26 (or lip elements 25, 27), the seal 1 may have an improved pressure relationship on at least one axial side of the seal 1.

Seals described according to embodiments herein may allow for improved design customization and flexibility for a majority of applications including, but not limited to, seals applications. Further, seals described according to embodiments herein may allow for improved pressure/force balance in more difficult environments, such as those with high pressure requirements, operating/rotational speeds, and volatile fluids. Further, seals described according to embodiments herein may allow for higher contact pressure and improved leakage performance over time in these difficult environments. Resultantly, seals described according to embodiments herein may allow for the components of the seal and surrounding components to have a longer lifetime due to appropriately placed forces that lessen repeat compression and stressing of the individual components due to vibration or actuation of the seal or other components within the assembly. Further, the seal described according to embodiments herein may prevent seal deformation under low and high cyclic pressure cycles. As a result, the lifetime of the components and the seal itself may be improved and overall leakage may be lessened.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. A rotary shaft seal comprising: an annular body having an aperture defining a central axis and an inner surface; a shaft disposed within the aperture of the annular body; and a sealing element positioned at least partially between the shaft and the annular body, wherein the sealing element is configured to form a seal between the annular body and the shaft, wherein the sealing element has a U-shaped or a V-shaped cross-section comprising at least one lip element, wherein the at least one lip element of the sealing element is fixed to at least one of the shaft or the annular body, and wherein a cavity exists between the at least one lip element and at least one of the shaft or the annular body.

Embodiment 2. A rotary shaft seal comprising: an annular body having an aperture defining a central axis and an inner surface; a shaft disposed within the aperture of the annular body; and a sealing element positioned at least partially between the shaft and the annular body, wherein the sealing element is configured to form a seal between the annular body and the shaft, wherein the sealing element has a U-shaped or a V-shaped cross-section comprising a plurality of lips, wherein a cavity exists between at least one of the plurality of lip elements and at least one of the shaft or the annular body, and wherein a first lip element of the plurality of lips has an inner surface area, B₁, on an interior side of the first lip, wherein a second lip of the plurality of lips has an inner surface area, B₂, on an interior side of the second lip, and wherein B₂/B₁ is less than 0.95.

Embodiment 3. A method comprising: providing an annular body having an aperture defining a central axis and an inner surface; providing a shaft; positioning a sealing element at least partially between the shaft and the annular body, wherein the sealing element is configured to form a seal between the annular body and the shaft, wherein the sealing element has a U-shaped or a V-shaped cross-section comprising at least one lip element; and fixing the at least one lip element of the sealing element to at least one of the shaft or the annular body, wherein a cavity exists between the at least one lip element and at least one of the shaft or the annular body.

Embodiment 4. The rotary shaft seal or method according to any one of the preceding embodiments, wherein the body defines an aperture coaxial with the central axis.

Embodiment 5. The rotary shaft seal or method according to embodiment 2, wherein B₂/B₁ is between 0.5-0.95.

Embodiment 6. The rotary shaft seal or method according to any one of the preceding embodiments, wherein the rotary shaft seal is adapted to receive a shaft through the aperture, the shaft having a diameter of no greater than 120 mm, no greater than 100 mm, no greater than 75 mm, no greater than about 50 mm, no greater than about 15 mm, no greater than about 10 mm, no greater than about 9 mm, no greater than about 8 mm, no greater than about 7 mm, no greater than about 6 mm, or no greater than about 5 mm.

Embodiment 7. The rotary shaft seal or method according to any one of the preceding embodiments, wherein the rotary shaft seal is adapted to operate at temperatures within a range between about −275° C. and about 350° C., between about −250° C. and about 250° C., between about −100° C. and about 100° C., or between about −40° C. and about 20° C.

Embodiment 8. The rotary shaft seal or method according to at least one of the preceding embodiments, wherein the sealing element is fixed to at least one of the shaft or the annular body via a chemical fixation or a mechanical fixation.

Embodiment 9. The rotary shaft seal according to embodiment 8, wherein the sealing element is fixed to at least one of the shaft or the annular body via a chemical fixation comprising an adhesive including at least one of fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), FEP, copolymers thereof, or any combination thereof.

Embodiment 10. The rotary shaft seal according to embodiment 8, wherein the sealing element is fixed to at least one of the shaft or the annular body via a mechanical fixation comprising at least one of nuts, bolts, bearings, battens, buckles, clips, flanges, frogs, grommets, hook-and-eyes, latches, pegs, nails, rivets, tongue- and grooves, screw anchors, snap fasteners, stitches, threaded fasteners, ties, toggle bolts, wedges anchors, screws, biasing element, bolts, clamps, clasps, clips, latches, pins, rivets, ties, nails, or any combination thereof.

Embodiment 11. The rotary shaft seal or method according to any one of the preceding embodiments, wherein the annular body defines an outer member having a first end and a second end, a first flange disposed proximate the first end of the outer member and extending radially inward from the outer member, and a second flange disposed proximate the second end of the outer member and extending radially inward from the outer member.

Embodiment 12. The rotary shaft seal or method according to embodiment 11, wherein the first flange extends a radial distance, D1, as measured from the outer member, wherein the second flange extends a radial distance, D2, as measured from the outer member, and wherein D1 is no less than D2.

Embodiment 13. The rotary shaft seal or method according to embodiment 12, wherein D1/D2 is at least about 1.01, at least about 1.05, at least about 1.25, at least about 1.50, at least about 1.75, at least about 2.0, at least about 2.25, at least about 2.50, at least about 2.75, or at least about 3.0.

Embodiment 14. The rotary shaft seal or method according to any one of embodiments 11 or 12, wherein D1/D2 is no greater than about 6.0, no greater than about 5.0, no greater than about 4.0, or no greater than about 3.5.

Embodiment 15. The rotary shaft seal or method according to any one of embodiments 12-14, wherein the outer member has a height, HOM, and wherein HOM/D2 is at least about 0.5, at least about 0.75, at least about 1.0, at least about 1.25, at least about 1.5, or at least about 2.0.

Embodiment 16. The rotary shaft seal or method according to embodiment 15, wherein HOM/D2 is no greater than about 8.0, no greater than about 7.0, no greater than about 6.0, no greater than about 5.0, no greater than about 4.0, or no greater than about 3.0.

Embodiment 17. The rotary shaft seal or method according to any one of the preceding embodiments, wherein the annular body defines an annular cavity within the central axis of the aperture and extending outward from the central axis and into the annular body.

Embodiment 18. The rotary shaft seal or method according to embodiment 17, wherein the sealing element is disposed at least partially within the annular cavity.

Embodiment 19. The rotary shaft seal or method according to any one of the preceding embodiments, wherein the annular body comprises a material having a Brinell hardness (HB) in a range of about 70 to about 150, in a range of about 75 to about 145, in a range of about 80 to about 140, in a range of about 85 to about 135, in a range of about 90 to about 130, in a range of about 95 to about 125, in a range of about 100 to about 120, or in a range of about 105 to about 115.

Embodiment 20. The rotary shaft seal or method according to any one of the preceding embodiments, wherein the annular body comprises a metal or a polymer.

Embodiment 21. The rotary shaft seal or method according to embodiment 20, wherein the annular body comprises a polymer comprising a thermoplastic polymer or a thermoset polymer.

Embodiment 22. The rotary shaft seal or method according to any one of the preceding embodiments, wherein the sealing element defines a first axial end and a second axial end, a first flange comprising a lip element and disposed proximate the first axial end of sealing element and extending at least partially radially inward, and a second flange comprising a lip element and disposed proximate the second axial end of the sealing element and extending at least partially radially inward.

Embodiment 23. The rotary shaft seal or method according to embodiment 22, wherein the first flange extends a length, L₁, as measured from the second axial end, wherein the second flange extends a length, L₂, as measured from the second axial end, and wherein L₁ is no less than L₂.

Embodiment 24. The rotary shaft seal or method according to embodiment 23, wherein L₁/L₂ is at least about 1.01, at least about 1.05, at least about 1.25, at least about 1.50, at least about 1.75, at least about 2.0, at least about 2.25, at least about 2.50, at least about 2.75, or at least about 3.0.

Embodiment 25. The rotary shaft seal or method according to any one of embodiments 21 or 22, wherein L₁/L₂ is no greater than about 6.0, no greater than about 5.0, no greater than about 4.0, or no greater than about 3.5.

Embodiment 26. The rotary shaft seal or method according to any one of embodiments 21-25, wherein the first flange forms a relative angle, A1, with the outer member as measured in the undeformed state, and wherein A1 is greater than about 90 degrees, greater than about 100 degrees, greater than about 110 degrees, greater than about 120 degrees, greater than about 130 degrees, or greater than about 140 degrees.

Embodiment 27. The rotary shaft seal or method according to embodiment 26, wherein A1 is less than about 180 degrees, less than about 170 degrees, less than about 160 degrees, or less than about 150 degrees.

Embodiment 28. The rotary shaft seal or method according to any one of embodiments 21-27, wherein the second flange forms a relative angle, A2, with the outer member as measured in the undeformed state, and wherein A2 is at least about 90 degrees, at least about 100 degrees, at least about 110 degrees, at least about 120 degrees, at least about 130 degrees, or at least about 140 degrees.

Embodiment 29. The rotary shaft seal or method according to embodiment 28, wherein A2 is less than about 180 degrees, less than about 170 degrees, less than about 160 degrees, or less than about 150 degrees.

Embodiment 30. The rotary shaft seal or method according to any one of the preceding embodiments, wherein the sealing element comprises a generally V-shaped cross-section when viewed in a direction perpendicular to a plane extending radially from the central axis.

Embodiment 31. The rotary shaft seal or method according to embodiment 30, wherein the sealing element comprises a first flange and a second flange having a relative angle, A3, as measured therebetween in the undeformed state, and wherein A3 is no less than about 20 degrees, no less than about 30 degrees, no less than about 40 degrees, no less than about 50 degrees, no less than about 60 degrees, no less than about 70 degrees, no less than about 80 degrees, or no less than about 90 degrees.

Embodiment 32. The rotary shaft seal or method according to embodiment 31, wherein A3 is no greater than about 150 degrees, no greater than about 140 degrees, no greater than about 130 degrees, no greater than about 120 degrees, no greater than about 110 degrees, or no greater than about 100 degrees.

Embodiment 33. The rotary shaft seal or method according to any one of the preceding embodiments, wherein the sealing element has a generally U-shaped cross-section when viewed in a direction perpendicular to a plane extending radially from the central axis.

Embodiment 34. The rotary shaft seal or method according to any one of the preceding embodiments, wherein the sealing element comprises a material having a Modulus of Elasticity (MOE) of no less than about 0.05 gigaPascal (GPa), no less than about 0.5 GPa, no less than about 0.75 GPa, or no less than about 1.0 GPa.

Embodiment 35. The rotary shaft seal or method according to embodiment 34, wherein the sealing element comprises a material having an MOE of no greater than about 5.0 Gpa, no greater than about 4.0 GPa, no greater than about 3.0 Gpa, no greater than about 2.0 GPa, or no greater than about 1.5 GPa.

Embodiment 36. The rotary shaft seal or method according to any one of the preceding embodiments, wherein the sealing element comprises a thermoplastic polymer.

Embodiment 37. The rotary shaft seal or method according to any one of the preceding embodiments, wherein the sealing element comprises a fluoropolymer, such as polytetrafluoroethylene (PTFE).

Embodiment 38. The rotary shaft seal or method according to any one of the preceding embodiments, wherein the sealing element comprises an ethylene tetrafluoroethylene (ETFE), ETFE copolymer, or a perfluoroalkoxy alkane (PFA).

Embodiment 39. The rotary shaft seal or method according to any one of the preceding embodiments, wherein the sealing element comprises a monolithic piece.

Embodiment 40. The rotary shaft seal or method according to any one of the preceding embodiments, wherein the sealing element comprises an average thickness, TSE, when viewed in a direction perpendicular to a plane extending radially from the central axis, and wherein TSE is no less than about 0.05 inches, no less than about 0.10 inches, no less than about 0.15 inches, or no less than about 0.20 inches.

Embodiment 41. The rotary shaft seal or method according to embodiment 40, wherein TSE is no greater than about 0.75 inches, no greater than about 0.50 inches, or no greater than about 0.25 inches.

Embodiment 42. The rotary shaft seal or method according to embodiment 8, wherein the mechanical fixation comprises a biasing element biasing at least a portion of the sealing element in a radial direction to fix the sealing element to the annular body.

Embodiment 43. The rotary shaft seal or method according to embodiment 42, wherein the sealing element is positioned between the biasing element and the annular body when viewed in a direction perpendicular to a plane extending radially from the central axis.

Embodiment 44. The rotary shaft seal or method according to any one of embodiments 42-43, wherein the biasing element comprises a spring.

Embodiment 45. The rotary shaft seal or method according to any one of embodiments 42-44, wherein the biasing element comprises a generally planar cross-section when viewed in a direction perpendicular to a plane extending radially from the central axis.

Embodiment 46. The rotary shaft seal or method according to any one of embodiments 42-45, wherein the biasing element comprises an annular member and an annular flange extending from the annular member, wherein a relative angle, A4, is formed between the annular member and the annular flange, and wherein A4 is greater than about 90 degrees, greater than about 100 degrees, or greater than about 110 degrees.

Embodiment 47. The rotary shaft seal or method according to embodiment 46, wherein A4 is less than about 150 degrees, less than about 140 degrees, less than about 130 degrees, or less than about 120 degrees.

Embodiment 48. The rotary shaft seal or method according to any one of embodiments 42-47, wherein the biasing element comprises an annular spring disposed along an inner surface of the sealing element.

Embodiment 49. The rotary shaft seal or method according to embodiment 48, wherein the biasing element comprises a garter spring.

Embodiment 50. The rotary shaft seal or method according to embodiment 48, wherein the biasing element comprises a compression spring.

Embodiment 51. The rotary shaft seal or method according to any one of embodiments 42-50, wherein the biasing element further comprises an axial gap.

Embodiment 52. The rotary shaft seal or method according to any one of embodiments 42-51, wherein the biasing element is disposed radially inside of at least one of the lip elements of the sealing element.

Embodiment 53. The rotary shaft seal or method according to any one of embodiments 42-52, wherein the biasing element comprises a material having a Modulus of Elasticity of no less than about 5.0 gigaPascal (GPa), no less than about 10.0 GPa, no less than about 25.0 GPa, no less than about 50 GPa, no less than about 100 GPa, or no less than about 150 GPa.

Embodiment 54. The rotary shaft seal or method according to any one of embodiments 42-53, wherein the biasing element comprises a material having a Modulus of Elasticity of no greater than about 300 GPa, no greater than about 250 GPa, or no greater than about 225 GPa.

Embodiment 55. The rotary shaft seal or method according to any one of embodiments 42-54, wherein the biasing element comprises a material having a tensile strength of no less than about 1000 megaPascals (MPa), no less than about 1200 MPa, or no less than about 1500 MPa.

Embodiment 56. The rotary shaft seal or method according to any one of embodiments 42-55, wherein the biasing element comprises a material having a tensile strength of no greater than about 2500 megaPascals (MPa), no greater than about 2000 MPa, or no greater than about 1800 MPa.

Embodiment 57. The rotary shaft seal or method according to any one of embodiments 42-56 wherein the biasing element, when assembled within the rotary shaft seal, provides a biasing force of at least about 1.0 kilopascals (KPa), at least about 5 KPa, at least about 10 KPa, at least about 25 KPa, at least about 50 KPa, at least about 100 KPa, or at least about 250 KPa.

Embodiment 58. The rotary shaft seal or method according to any one of embodiments 42-57, wherein the biasing element, when assembled within the rotary shaft seal, provides a biasing force of no greater than about 500 KPa, no greater than about 400 KPa, or no greater than about 300 KPa.

Embodiment 59. The rotary shaft seal or method according to any one of embodiments 42-58, wherein the biasing element comprises a metal.

Embodiment 60. The rotary shaft seal or method according to any one of embodiments 42-59, wherein the biasing element comprises spring steel.

Embodiment 61. The rotary shaft seal or method according to any one of the preceding embodiments, wherein the cavity has a rectilinear cross-section.

Embodiment 62. The rotary shaft seal or method according to any one of the preceding embodiments, wherein the cavity has an arcuate cross-section.

Embodiment 63. The rotary shaft seal or method according to any one of the preceding embodiments, wherein the cavity has an arcuate and a rectilinear cross-section.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A rotary shaft seal comprising:
an annular body having an aperture defining a central axis and an inner surface;
a shaft disposed within the aperture of the annular body; and
a sealing element positioned at least partially between the shaft and the annular body, wherein the sealing element is configured to form a seal between the annular body and the shaft, wherein the sealing element has a U-shaped or a V-shaped cross-section comprising at least one lip element, wherein the at least one lip element of the sealing element is fixed to at least one of the shaft or the annular body, and wherein a cavity exists between the at least one lip element and at least one of the shaft or the annular body.

2. A rotary shaft seal comprising:
an annular body having an aperture defining a central axis and an inner surface;
a shaft disposed within the aperture of the annular body; and
a sealing element positioned at least partially between the shaft and the annular body, wherein the sealing element is configured to form a seal between the annular body and the shaft, wherein the sealing element has a U-shaped or a V-shaped cross-section comprising a plurality of lips, wherein a cavity exists between at least one of the plurality of lip elements and at least one of the shaft or the annular body, and wherein a first lip element of the plurality of lips has an inner surface area, B₁, on an interior side of the first lip, wherein a second lip of the plurality of lips has an inner surface area, B₂, on an interior side of the second lip, and wherein B₂/B₁ is less than 0.95.

3. A method comprising:
providing an annular body having an aperture defining a central axis and an inner surface;
providing a shaft;
positioning a sealing element at least partially between the shaft and the annular body, wherein the sealing element is configured to form a seal between the annular body and the shaft, wherein the sealing element has a U-shaped or a V-shaped cross-section comprising at least one lip element; and
fixing the at least one lip element of the sealing element to at least one of the shaft or the annular body, wherein a cavity exists between the at least one lip element and at least one of the shaft or the annular body.

4. The rotary shaft seal of claim 1, wherein the body defines an aperture coaxial with the central axis.

5. The rotary shaft seal of claim 2, wherein B₂/B₁ is between 0.5-0.95.

6. The rotary shaft seal of claim 1, wherein the rotary shaft seal is adapted to receive a shaft through the aperture, the shaft having a diameter of no greater than 120 mm, no greater than 100 mm, no greater than 75 mm, no greater than about 50 mm, no greater than about 15 mm, no greater than about 10 mm, no greater than about 9 mm, no greater than about 8 mm, no greater than about 7 mm, no greater than about 6 mm, or no greater than about 5 mm.

7. The rotary shaft seal of claim 1, wherein the rotary shaft seal is adapted to operate at temperatures within a range between about −275° C. and about 350° C., between about −250° C. and about 250° C., between about −100° C. and about 100° C., or between about −40° C. and about 20° C.

8. The rotary shaft seal of claim 1, wherein the sealing element is fixed to at least one of the shaft or the annular body via a chemical fixation or a mechanical fixation.

9. The rotary shaft seal of claim 1, wherein the annular body defines an outer member having a first end and a second end, a first flange disposed proximate the first end of the outer member and extending radially inward from the outer member, and a second flange disposed proximate the second end of the outer member and extending radially inward from the outer member.

10. The rotary shaft seal of claim 8, wherein the first flange extends a radial distance, D1, as measured from the outer member, wherein the second flange extends a radial distance, D2, as measured from the outer member, and wherein D1 is no less than D2.

11. The rotary shaft seal of claim 1, wherein the annular body defines an annular cavity within the central axis of the aperture and extending outward from the central axis and into the annular body.

12. The rotary shaft seal of claim 11, wherein the sealing element is disposed at least partially within the annular cavity.

13. The rotary shaft seal of claim 1, wherein the sealing element defines a first axial end and a second axial end, a first flange comprising a lip element and disposed proximate the first axial end of sealing element and extending at least partially radially inward, and a second flange comprising a lip element and disposed proximate the second axial end of the sealing element and extending at least partially radially inward.

14. The rotary shaft seal of claim 13, wherein the first flange extends a length, L₁, as measured from the second axial end, wherein the second flange extends a length, L₂, as measured from the second axial end, and wherein L₁ is no less than L₂.

15. The rotary shaft seal of claim 13, wherein the first flange forms a relative angle, A1, with the outer member as measured in the undeformed state, and wherein A1 is greater than about 90 degrees, greater than about 100 degrees, greater than about 110 degrees, greater than about 120 degrees, greater than about 130 degrees, or greater than about 140 degrees.

16. The rotary shaft seal of claim 13, wherein the second flange forms a relative angle, A2, with the outer member as measured in the undeformed state, and wherein A2 is at least about 90 degrees, at least about 100 degrees, at least about 110 degrees, at least about 120 degrees, at least about 130 degrees, or at least about 140 degrees.

17. The rotary shaft seal of claim 1, wherein the sealing element comprises a generally V-shaped cross-section when viewed in a direction perpendicular to a plane extending radially from the central axis.

18. The rotary shaft seal of claim 17, wherein the sealing element comprises a first flange and a second flange having a relative angle, A3, as measured therebetween in the undeformed state, and wherein A3 is no less than about 20 degrees, no less than about 30 degrees, no less than about 40 degrees, no less than about 50 degrees, no less than about 60 degrees, no less than about 70 degrees, no less than about 80 degrees, or no less than about 90 degrees.

19. The rotary shaft seal of claim 1, wherein the sealing element has a generally U-shaped cross-section when viewed in a direction perpendicular to a plane extending radially from the central axis.

20. The rotary shaft seal of claim 19, wherein the mechanical fixation comprises a biasing element biasing at least a portion of the sealing element in a radial direction to fix the sealing element to the annular body.
